(19) United States
(12) Patent Application Publication
(10) Pub. No.: US 2026/0010856 A1
(43) Pub. Date: Jan. 8, 2026

(54) PREDICTION ASSESSMENT TOOL

(71) Applicant: Standard Software AI, LLC, Uniontown, OH (US)

(72) Inventor: Luis F. PENEDO, Uniontown, OH (US)

(73) Assignee: Standard Software AI, LLC, Uniontown, OH (US)

(21) Appl. No.: 19/085,614

(22) Filed: Mar. 20, 2025

Related U.S. Application Data
(60) Provisional application No. 63/667,319, filed on Jul. 3, 2024.

(51) Int. Cl. G06Q 10/0637; G06Q 50/06; G06Q 50/22

(52) U.S. Cl. CPC G06Q 10/0637; G06Q 50/06; G06Q 50/22

(57) ABSTRACT

The present teaching relates to an artificial intelligence powered system and method for creating and managing reports related to physical and safety related assets, as well as managing the technology assigned to clients to enhance their abilities for their daily activities, and for assessing the conditions of physical and safety related assets, patients, and the patients' respective assistive technologies assigned to them to enhance their abilities for their daily activities.

### FIELD

This application claims priority to U.S. Ser. No. 63/667,319, filed Jul. 3, 2024, the contents of which are hereby incorporated by reference. The present teaching relates generally to an artificial intelligence powered system and method for providing predictions and assessments in the field of IT solutions.

### BACKGROUND

The IT industry is currently suffering from economic pressures as consumers try to spend less on IT solutions without compromising on quality. These pressures are being alleviated by artificial intelligence (AI) powered software. Artificial intelligence is intelligence exhibited by machines, particularly computer systems. It is a field of research in computer science that develops and studies methods and software that enable machines to perceive their environment and uses learning and intelligence to take actions that maximize their chances of achieving defined goals.

The growing use of artificial intelligence in the 21st century is influencing a societal and economic shift towards increased automation, data-driven decision-making, and the integration of AI systems into various economic sectors and areas of life, impacting job markets, healthcare, government, industry, and education. This raises questions about the long-term effects, ethical implications, and risks of AI, prompting discussions about regulatory policies to ensure the safety and benefits of the technology.

The various subfields of AI research are centered around particular goals and the use of particular tools. The traditional goals of AI research include reasoning, knowledge representation, planning, learning, natural language processing, perception, and support for robotics. General intelligence (the ability to complete any task performable by a human on an at least equal level) is among the field's long-term goals.

To reach these goals, researchers in the field of AI have adapted and integrated a wide range of techniques, including search and mathematical optimization, formal logic, artificial neural networks, and methods based on statistics, operations research, and economics. AI also draws upon psychology, linguistics, philosophy, neuroscience, and other fields.

The current state of the art includes the use of a static approach which means they only provide the means to gather information and store it.

As used herein, a Conversational User Interface (CUI) is a user interface that allows users to interact with the system using natural language, rather than through menus and buttons.

As used herein, Extract, Transform, Load (ETL) is a data integration method that combines, cleans, and organizes data from multiple sources into a single, consistent data set for storage. During data extraction, raw data is copied or exported from the source locations to a staging area. This data can then be either structured or unstructured. In the staging area, the raw data undergoes data processing, wherein the data is transformed and consolidated for its intended use. This process can include, but is not limited to, filtering, cleansing, aggregating, de-duplicating, validating, and authenticating the data; performing calculations, translations, or summarizations based on the raw data, which can include but is not limited to changing row and column headers, converting currencies or other units of measure, and editing text strings; conducting audits to ensure data quality and compliance, along with computing metrics; removing, encrypting, and/or protecting data governed by industry or governmental regulations/regulators; and formatting the data into tables or joined tables to match the schema of a target data destination, including but not limited to tables, databases, data warehouses, and data lakes. The transformed data is then moved from the staging area into a target data destination. This generally involves an initial loading of all data, followed by a periodic loading of incremental data changes and, less often, full refreshes to erase and replace data in the target data destination.

As used herein, the phrases “at least one” and “one or more” are equivalent in definition and use. These two phrases can be used interchangeably. As used herein, the words “data” and “information” are equivalent in definition and use. These two words can be used interchangeably.

### SUMMARY

The Prediction Assessment Tool is a system which trains and utilizes artificial intelligence models to make assessments and predictions regarding certain outcomes and conditions. Information gathered by an individual, a computer program, or the system is used by the system to make an assessment or prediction regarding the status of a condition, item, or situation. Applications of this system include but are not limited to condition assessment inspections to physical assets, assessing existing safety conditions, and assessing a person's capability and assigning assistive technology for their daily activities.

### BRIEF DESCRIPTION OF THE DRAWINGS

The present disclosure may take a physical form in certain parts and an arrangement of parts, aspects of which will be described in detail in this specification and illustrated in the accompanying drawings which form a part hereof and wherein:

FIG. 1 schematically presents a flow chart giving a high-level description of the prediction assessment tool process in accordance with aspects of the present disclosure.

FIG. 2 schematically presents a flow chart giving a detailed description of the training process in accordance with aspects of the present disclosure.

FIG. 3 schematically presents a flow chart giving a detailed description of the assessment process in accordance with aspects of the present disclosure.

FIG. 4 schematically presents a flow chart giving an overview of the training and prediction processes in accordance with aspects of the present disclosure.

FIG. 5 schematically presents a flow chart giving a detailed description of the training process software operational flow in accordance with aspects of the present disclosure.

FIG. 6 schematically presents a flow chart giving a detailed description of the prediction process software operational flow in accordance with aspects of the present disclosure.

FIG. 7 showcases an exemplary table filled in with variables.

FIG. 8 showcases another exemplary table filled in with completed inspection reports.

FIG. 9 schematically presents a flow chart giving an overview of the data analysis process in accordance with aspects of the present disclosure.

FIG. 10 schematically presents a flow chart giving an overview of the assessment process in accordance with aspects of the present disclosure.

### DETAILED DESCRIPTION

The following detailed description is merely exemplary in nature and is not intended to limit the described aspects or the application and uses of the described aspects. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the aspects of the disclosure and are not intended to limit the scope of the disclosure, which is defined by the claims.

Disclosed is a system and method for predicting and assessing the actual value of an event using AI based models that rely on criteria of past observations that were fed to the model.

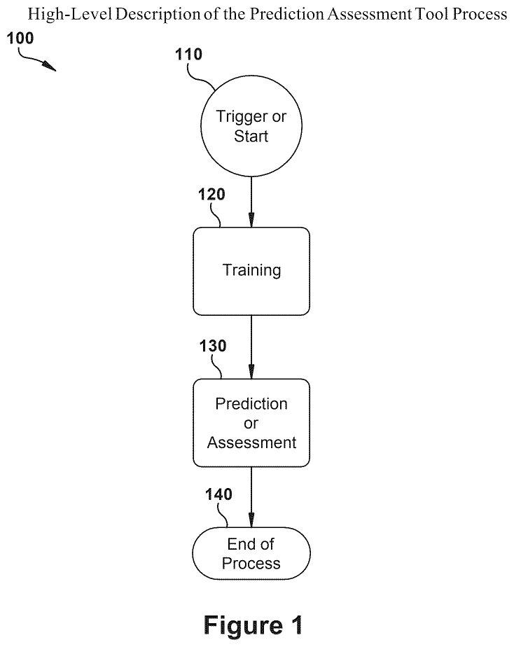

FIG. 1 schematically presents a High-Level Description of the Prediction Assessment Tool Process flowchart 100. The High-Level Description of the Prediction Assessment Tool Process flowchart 100 includes a Trigger or Start Step 110, a Training Step 120, a Prediction or Assessment Step 130, and an End of Process Step 140.

The Trigger or Start Step 110 is a step in which the user or system triggers the beginning of the prediction assessment tool process. This step may be triggered by pressing on a button or a keyboard key, clicking on a button, clicking on a link, or by any other triggering event, such as using a scheduled process that runs on the application host server or a time triggered cloud function that runs at specific time intervals such as once a day or once a week, as non-limiting examples.

The Training Step 120 is a step in which information is fed into one or more structured models. The structure of the one or more structured models can be any structure suitable for representing a collection of data showcasing past or hypothetical future observations. The data may be organized as a collection of records that can be viewed as a table on which each row is a record with at least one attribute or value.

The Prediction or Assessment Step 130 is a step in which a prediction or assessment is made based on the one or more structured models created during the Training Step 120.

The End of Process Step 140 is a step which marks the end of the prediction assessment tool process.

The flow of the High-Level Description of the Prediction Assessment Tool Process flowchart 100 is described herein. When a prediction or assessment needs to be made, the user and/or the system may begin the prediction assessment tool process by triggering or starting the process via the Trigger or Start Step 110. Once the Trigger or Start Step 110 has been triggered or started, the system executes the Training Step 120, wherein the system creates and/or trains one or more models using information from various sources. Once the one or more models are trained, the system executes the Prediction or Assessment Step 130, wherein the system uses the models to make predictions and assessments. Once the Prediction or Assessment Step 130 is completed, the system executes the End of Process Step 140, marking the end of the prediction assessment tool process.

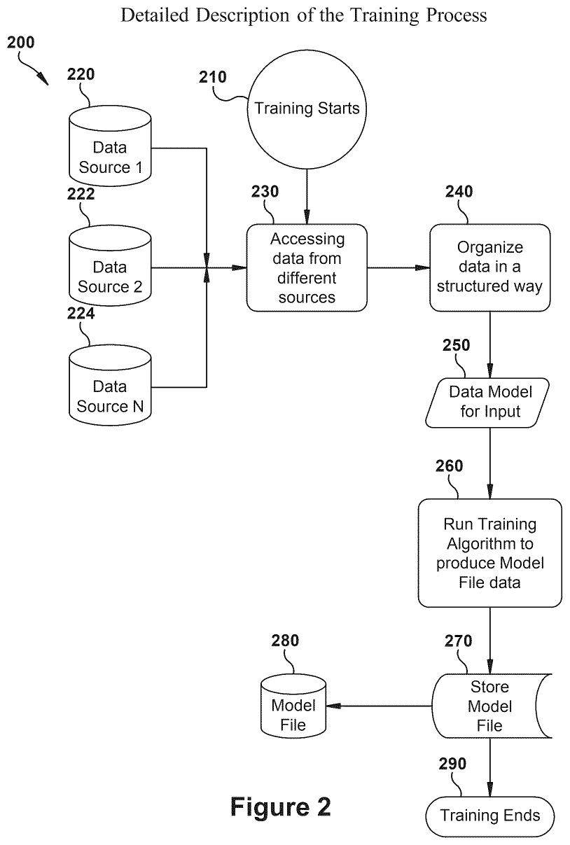

FIG. 2 schematically presents a Detailed Description of the Training Process flowchart 200. The Detailed Description of the Training Process flowchart 200 includes a Training Starts Step 210, a Data Source 1 220, a Data Source 2 222, a Data Source N 224, an Accessing Data from Different Sources Step 230, an Organize Data in a Structured Way Step 240, a Data Model for Input 250, a Run Training Algorithm Step 260, a Store Model File Step 270, a Model File Database 280, and a Training Ends Step 290.

The Training Starts Step 210 is a step which marks the beginning of the training process. This step may be triggered by pressing on a button or a keyboard key, clicking on a button, clicking on a link, or by any other triggering event, such as using a scheduled process that runs on the application host server or a time triggered cloud function that runs at specific time intervals such as once a day or once a week, as non-limiting examples.

The Data Source 1 220 is a data source from which data is harvested by the system for use in the training process.

The Data Source 2 222 is a data source from which data is harvested by the system for use in the training process. The Data Source 2 222 is a separate data source from the Data Source 1 220.

The Data Source N 224 is a data source from which data is harvested by the system for use in the training process. The “N” indicates that any number of data sources may be used by the system for the training process, any number from 1 to N, N being theoretically infinite. The Data Source N 224 represents the last data source used by the system for the training process.

The Accessing Data from Different Sources Step 230 is a step in which the system accesses information stored in the Data Source 1 220, the Data Source 2 222, and the Data Source N 224.

The Organize Data in a Structured Way Step 240 is a step in which the data collected in the Accessing Data from Different Sources Step 230 is organized in a structured way. This structure can be any structure suitable for representing a collection of data showcasing past or hypothetical future observations. The data is organized as a collection of records that can be viewed as a table on which each row is a record with at least one attribute or value.

The Data Model for Input 250 is one or more models comprising the information organized by the Organize Data in a Structured Way Step 240.

The Run Training Algorithm Step 260 is a step in which an algorithm is run using information from the Data Model for Input 250. The output of this step is a model file containing one or more trained models that is stored in the Model File Database 280 for use in the assessment process.

The Store Model File Step 270 is a step in which the results of the Run Training Algorithm Step 260 are stored in the Model File Database 280.

The Model File Database 280 is a database in which model files are stored.

The Training Ends Step 290 is a step which marks the end of the training process.

The flow of the Detailed Description of the Training Process flowchart 200 is described herein. When one or more models need to be created and/or trained, the user and/or the system may begin the training process by triggering or starting the Training Starts Step 210. Once the Training Starts Step 210 has been triggered or started, the system executes the Accessing Data from Different Sources Step 230, wherein the system searches for and extracts data from a group of data sources including the Data Source 1 220, the Data Source 2 222, and the Data Source N 224. Once the system has gathered the data it needs to train the one or more models, the system executes the Organize Data in a Structured Way Step 240, wherein the data extracted during the Accessing Data from Different Sources Step 230 is organized and structured such that it can be used to train the one or more models. One the data is organized and structured, the data is inserted into at least one Data Model for Input 250, which is either an existing model or a new model. Once the at least one Data Model for Input 250 has been filled with the organized and structured data, the system executes the Run Training Algorithm Step 260, wherein the at least one Data Model for Input 250 is trained using a training algorithm. Once the Run Training Algorithm Step 260 is complete, the system executes the Store Model File Step 270, wherein the one or more trained models are stored in the Model File Database 280. The system then executes the Training Ends Step 290, marking the end of the training process.

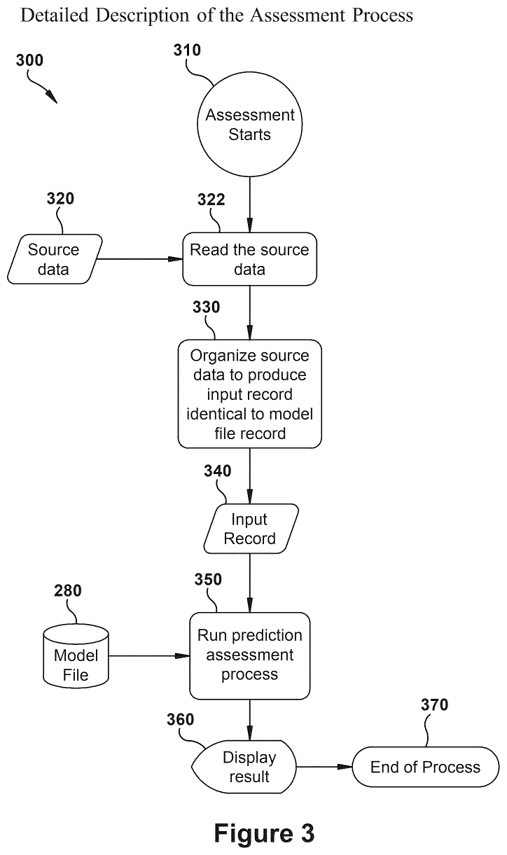

FIG. 3 schematically presents a Detailed Description of the Assessment Process flowchart 300. The Detailed Description of the Assessment Process flowchart 300 includes an Assessment Starts Step 310, a Source Data 320, a Read the Source Data Step 322, an Organize Source Data Step 330, an Input Record 340, a Prediction Assessment Process Step 350, the Model File Database 280 from FIG. 2, a Display Result Step 360, and an End of Process Step 370.

The Assessment Starts Step 310 is a step which marks the beginning of the assessment process. This step 310 may be triggered by pressing on a button or a keyboard key, clicking on a button, clicking on a link, or by any other triggering event, such as using a scheduled process that runs on the application host server or a time triggered cloud function that runs at specific time intervals such as once a day or once a week, as non-limiting examples.

The Source Data 320 is at least one source of data that the system draws from to make its assessment.

The Read the Source Data Step 322 is a step in which data is obtained from the Source Data 320.

The Organize Source Data Step 330 is a step in which data obtained from the Source Data 320 is organized and formatted to match the structure and formatting of the model files.

The Input Record 340 is a record which stores information organized in the Organize Source Data Step 330.

The Prediction Assessment Process Step 350 is a step in which the system makes a prediction based on information contained within the Model File Database 280 from FIG. 2 and the Input Record 340.

The Display Result Step 360 is a step in which the results of the Prediction Assessment Process Step 350 are displayed.

The End of Process Step 370 is a step which marks the end of the assessment process.

The flow of the Detailed Description of the Assessment Process flowchart 300 is described herein. When an assessment needs to be made, the user and/or the system may begin the assessment process by triggering or starting the Assessment Starts Step 310. Once the Assessment Starts Step 310 has been triggered or started, the system executes the Read the Source Data Step 322, wherein the system extracts data from one or more data sources included in the Source Data 320. Once the system has obtained the necessary data from the Source Data 320, it will execute the Organize Source Data Step 330, wherein data obtained from the Source Data 320 is organized, structured, and formatted to match the structure and formatting of the model files stored in the Model File Database 280. When the Organize Source Data Step 330 is completed, the newly organized and formatted data is used to create at least one Input Record 340. The system then executes the Prediction Assessment Process Step 350 using the data enclosed in the at least one Input Record 340 and one or more models from the Model File Database 280. Once the system has made its assessment or prediction, the system executes the Display Result Step 360, wherein results of the Prediction Assessment Process Step 350 are displayed. The system then executes the End of Process Step 370, marking the end of the assessment process.

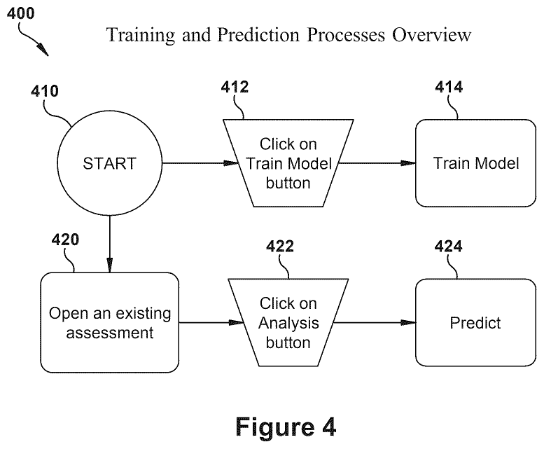

FIG. 4 schematically presents a Training and Prediction Processes Overview flowchart 400. The Training and Prediction Processes Overview flowchart 400 includes a Start Step 410, a Click on Train Model Button Step 412, a Train Model Step 414, an Open an Existing Assessment Step 420, a Click on Analysis Button Step 422, and a Predict Step 424.

The Start Step 410 is a step which marks the beginning of the training and/or prediction processes. This step 410 may be triggered by pressing on a button or a keyboard key, clicking on a button, clicking on a link, or by any other triggering event, such as using a scheduled process that runs on the application host server or a time triggered cloud function that runs at specific time intervals such as once a day or once a week, as non-limiting examples.

The Click on Train Model Button Step 412 is a step in which the user triggers the Train Model Step 414 by clicking on a button or by some other triggering means. This step 412 may also be executed by the system by using a schedule process that will run periodically, including but not limited to daily and weekly, from a server of from a cloud function, to verify there are enough records available to train the model. If there are, the scheduled process will trigger the training process to be executed.

The Train Model Step 414 is a step in which one or more models contained within the system are trained.

The Open an Existing Assessment Step 420 is a step in which the user or the system opens at least one existing assessment for the purposes of making a prediction based on the information contained within that at least one existing assessment.

The Click on Analysis Button Step 422 is a step in which the user triggers the Predict Step 424 by clicking on a button or by some other triggering means. This step 422 may also be executed by the system.

The Predict Step 424 is a step in which the system makes a prediction based on the information contained within the at least one existing assessment opened during the Open an Existing Assessment Step 420.

The flow of the Training and Prediction Processes Overview flowchart 400 is described herein. When a model needs to be trained or a prediction needs to be made, the user and/or the system may do so by triggering or Start Step 410. Once the Start Step 410 has been triggered or started, the user and/or the system can select either train a model or make a prediction, via the Click on Train Model Button Step 412 or the Click on Analysis Button Step 422 respectively. If the user and/or the system perform the Train Model Button Step 412, the system will execute the Train Model Step 414, wherein a model is trained based on information and data available to the system. If there is not enough data to train the model, the system will display a message to let the user know that there is not enough data to complete the model training. If the user and/or the system wish to have the system make a prediction, the user and/or the system will have to choose an existing assessment via the Open an Existing Assessment Step 420 before clicking on the analysis button. If the user and/or the system perform the Click on Analysis Button Step 422, the system will execute the Predict Step 424, wherein the system uses data contained within the existing assessment to make a prediction. When the system has completed making its prediction, the system will display its prediction as a percent chance of a particular event happening or percent chance of an element or circumstance existing.

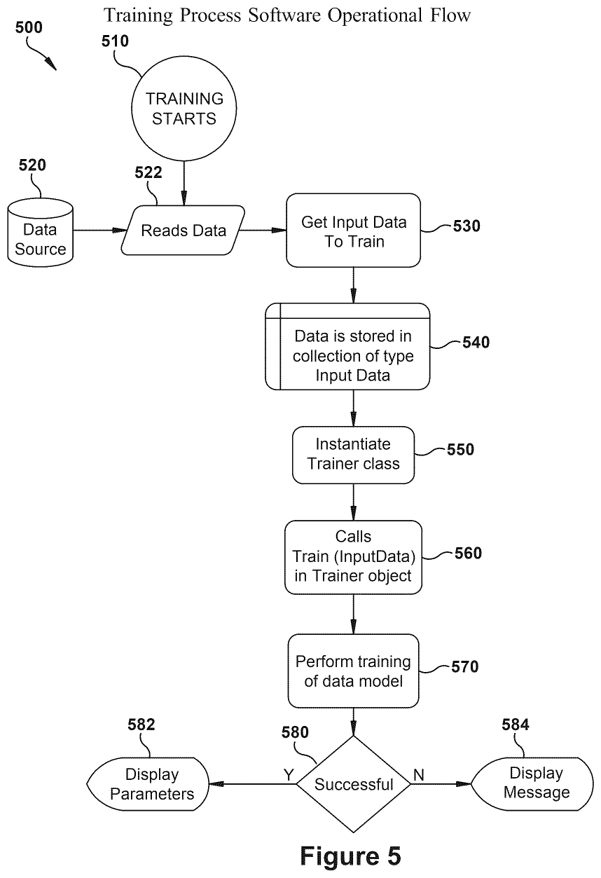

FIG. 5 schematically presents a Training Process Software Operational Flow flowchart 500. The Training Process Software Operational Flow flowchart 500 includes a Training Starts Step 510, a Data Source 520, a Reads Data Step 522, a Get Input Data to Train Step 530, a Data Storage Step 540, an Instantiate Trainer Class Step 550, a Calls Train Input Data Step 560, a Perform Training of Data Model Step 570, a Success Determination Step 580, a Display Parameters Step 582, and a Display Message Step 584.

The Training Starts Step 510 is a step which marks the beginning of the training process. This step 510 may be triggered by pressing on a button or a keyboard key, clicking on a button, clicking on a link, or by any other triggering event such as a schedule running periodically, including but not limited to daily and weekly.

The Data Source 520 is at least one source of data which the system uses to train its one or more models.

The Reads Data Step 522 is a step in which the system obtains data from the Data Source 520.

The Get Input Data to Train Step 530 is a step in which data obtained in the Reads Data Step 522 is analyzed and placed into a collection of elements of type InputData.

The Data Storage Step 540 is a step in which the collection of elements of type InputData compiled during the Get Input Data to Train Step 530 are stored for use in training the system's one or more models.

The Instantiate Trainer Class Step 550 is a step in which datapoints from the collection of elements of type InputData stored during the Data Storage Step 540 are used to instantiate a class named the trainer class.

The Calls Train Input Data Step 560 is a step in which a model training function is called by the system. In one aspect of the present teaching, this function takes the following form: Train (InputData). Once the collection of data of type InputData is built, that collection is sent as an argument of the train method of the trainer class object instantiated during the Instantiate Trainer Class Step 550.

The Perform Training of Data Model Step 570 is a step in which the one or more models of the system are trained using the model training function called by the system during the Calls Train Input Data Step 560.

The Success Determination Step 580 is a step in which the system determines whether the training process was successful.

The Display Parameters Step 582 is a step in which, if the Perform Training of Data Model Step 570 is determined to be successful by the Success Determination Step 580, the parameters of the one or more trained models are displayed.

The Display Message Step 584 is a step in which, if the Perform Training of Data Model Step 570 is determined to be unsuccessful by the Success Determination Step 580, a message is displayed informing the user the model training was unsuccessful.

The flow of the Training Process Software Operational Flow flowchart 500 is described herein. When one or more models need to be trained, the user and/or the system may begin the assessment process by triggering or starting the Training Starts Step 510. Once the Assessment Starts Step 510 has been triggered or started, the system executes the Reads Data Step 522, wherein the system reads the one or more databases and/or other data source(s) contained within the Data Source 520 to gather the necessary data for the training process. Once the system has the data it needs, the system executes the Get Input Data to Train Step 530, wherein the system gathers and formats the data into the type InputData. The system then executes the Data Storage Step 540, wherein the collection of data of type InputData formatted during the Get Input Data to Train Step 530 is stored for use in training the system's one or more models. The system then executes the Instantiate Trainer Class Step 550, wherein the data stored during the Data Storage Step 540 is used to instantiate a trainer class. The system then executes the Calls Train Input Data Step 560, wherein the system sends the data of type InputData as an argument of the train method of the trainer class object instantiated in the Instantiate Trainer Class Step 550. The system then executes the Perform Training of Data Model Step 570, wherein the system uses the information contained within the trainer class to train the one or more models. The system then executes the Success Determination Step 580, wherein the system determines whether the one or more models were trained properly and successfully. If so, the system will execute the Display Parameters Step 582, wherein the system displays the parameters of the one or more models for predictions. If the system determines that the one or more models were not trained properly and successfully, the system will execute the Display Message Step 584, wherein the system displays a message informing the user that the training process failed and provides a reason for the failure.

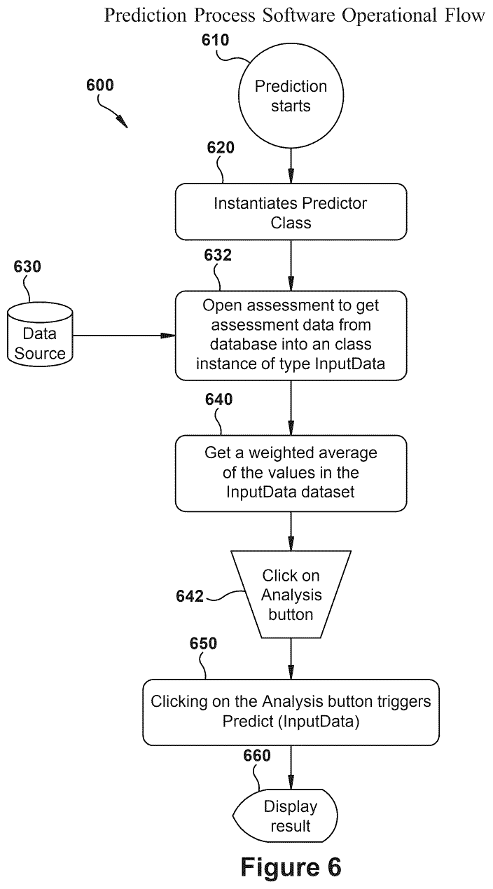

FIG. 6 schematically presents a Prediction Process Software Operational Flow flowchart 600. The Prediction Process Software Operational Flow flowchart 600 includes a Prediction Starts Step 610, an Instantiate Predictor Class Step 620, a Data Source 630, an Open Assessment Step 632, a Get Weighted Average Step 640, a Click on Analysis Button Step 642, a Prediction Trigger Step 650, and a Display Results Step 660.

The Prediction Starts Step 610 is a step which marks the beginning of the prediction process. This step 610 may be triggered by pressing on a button or a keyboard key, clicking on a button, clicking on a link, or by any other triggering event such as reaching a point in the flow of a CUI or using a scheduled process that runs on the application host server or a time triggered cloud function that runs at specific time intervals such as once a day or once a week, as non-limiting examples.

The Instantiate Predictor Class Step 620 is a step in which the system instantiates a predictor class. The predictor class object includes the prediction method.

The Data Source 630 is at least one source of data which the system uses to make its predictions. The data contained within the Data Source 630 includes but is not limited to assessment data.

The Open Assessment Step 632 is a step in which the system opens assessment data from the Data Source 630 and inserts it into the predictor class instantiated during the Instantiate Predictor Class Step 620. The assessment data from the Data Source 630 comprises collections of elements of type InputData.

The Get Weighted Average Step 640 is a step in which the system calculates the weighted average of the data contained within the predictor class.

The Click on Analysis Button Step 642 is a step in which the user and/or the system click on a button or performs some other triggering action to execute the Prediction Trigger Step 650.

The Prediction Trigger Step 650 is a step in which the prediction process is triggered, wherein the system executes a call function of form Predict (InputData).

The Display Results Step 660 is a step in which the results of the system's prediction process are displayed.

The flow of the Prediction Process Software Operational Flow flowchart 600 is described herein. When a prediction needs to be made, the user and/or the system may begin the prediction process by triggering or starting the Prediction Starts Step 610. Once the Prediction Starts Step 610 has been triggered or started, the system executes the Instantiate Predictor Class Step 620, wherein the system instantiates a predictor class. The system then executes the Open Assessment Step 632, wherein the system gathers data of type InputData from the Data Source 630 and inserts it into the predictor class instantiated during the Instantiate Predictor Class Step 620. The system then executes the Get Weighted Average Step 640, wherein the system calculates the weighted average of the data contained within the predictor class. The system then executes the Prediction Trigger Step 650, upon the user and/or the system executing the Click on Analysis Button Step 642. During the Prediction Trigger Step 650, the system will execute a call function of form Predict (InputData), which will run a prediction analysis to determine the likelihood of a certain outcome or the likelihood of the existence of a certain condition. Once the system executes the Prediction Trigger Step 650, it will execute the Display Results Step 660, wherein the system displays the results of the prediction process in the form of a message that indicates in terms of a percentage the likelihood of a certain outcome or the likelihood of the existence of a certain condition.

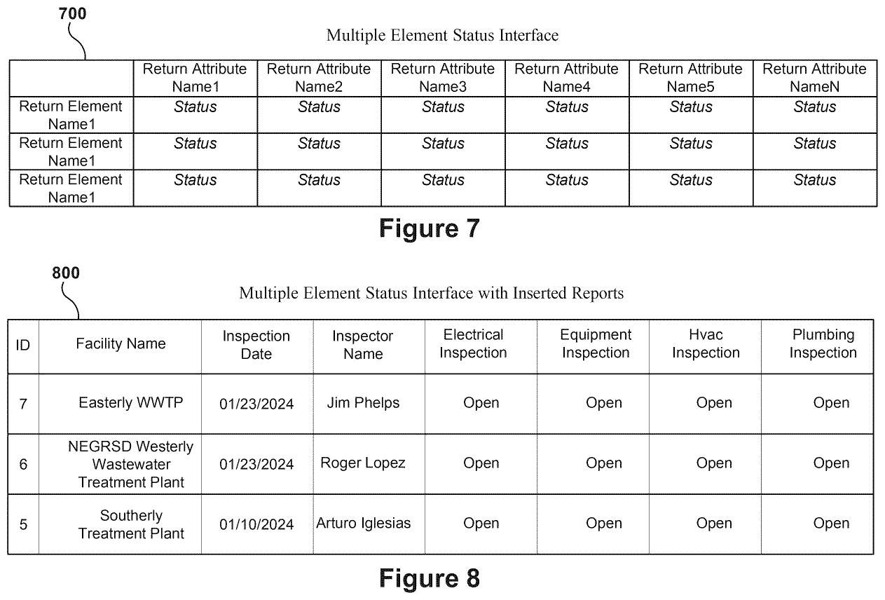

FIG. 7 depicts a Multiple Element Status Interface 700. The Multiple Element Status Interface 700 provides an exemplary table that shows various elements in a tabular view. The columns show the different categories or types of elements that are being tracked (Return Attribute Names). The rows show the element class or type name (Return Element Names). The content of the table shows a descriptive text for an action with a characteristic (that can be its color) that depends on attributes being saved for each element type to represent the status or stage of a category or type of an element.

In one aspect of the present disclosure, clicking on or otherwise interacting with a status element will open a window to access the category of an element data. If the data changes, depending on the change, the characteristic (e.g., color) or the representation of the element category in the table will change to help identify what elements have changed and how, and what characteristics each element has (e.g., complete, incomplete, in progress, etc. depending on what is of the goal or objective of the multiple element status interface implementation).

FIG. 8 depicts a Multiple Element Status Interface with Inserted Reports 800. The Multiple Element Status Interface with Inserted Reports 800 showcases an exemplary table wherein the user may open completed reports stored within the system by clicking or pressing on link contained within the Multiple Element Status Interface with Inserted Reports 800. Opening one of these completed reports will allow the user to view the contents of the report. The Multiple Element Status Interface with Inserted Reports 800 depicts an exemplary table with links to completed reports related to three different facilities, each with four different inspections, the associated dates, and the name of the inspector who created the report.

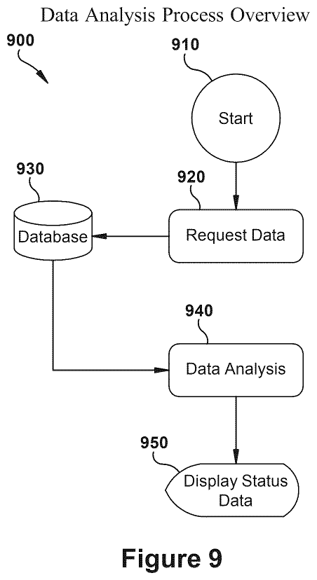

FIG. 9 schematically presents a Data Analysis Process Overview flowchart 900. The Data Analysis Process Overview flowchart 900 includes a Start Step 910, a Request Data Step 920, a Data Source 930, a Data Analysis Step 940, and a Display Status Data Step 950.

The Start Step 910 is a step which marks the beginning of the data analysis process. This step may be triggered by pressing on a button or a keyboard key, clicking on a button, clicking on a link, or by any other triggering event, such as using a scheduled process that runs on the application host server or a time triggered cloud function that runs at specific time intervals such as once a day or once a week, as non-limiting examples.

The Request Data Step 920 is a step in which data is requested from the Data Source 930. The request may be satisfied via a direct read from a table or through a query that gathers the data that is needed from different tables or from one. This process includes putting the data in a list of specific types. This list is called the Input List. This input list is a data structure having a collection of data elements with properties that correspond to the columns in the table of the user interface. Each element of the input list corresponds to one row in the user interface table. The purpose of this input list is to be used in the Data Analysis Step 940 to assign a value that is sent back to the user interface.

The Data Source 930 is at least one source of data.

The Data Analysis Step 940 is a step in which the data requested from the Data Source 930 is placed into an input list and analyzed. The input list provides a general view of the status of one or more items. In one aspect of the present disclosure, the input list comprises the columns of the user interface table. Once the input list is populated, the data of each element in the list is in a data structure that lets the system process the elements by iterating through the list and by analyzing the values of each property in each element. A return list is formed which is a list of return elements. Each return element in the return list is also a data structure with properties that reflect the columns in the table of the user interface, which is the same data structure as the input list but with different types of values. The input list may have numbers or characters, which the Data Analysis Step 940 processes to determine the values in the return element, which can be Boolean or a string that represents a status of the input element property. In one aspect of the present disclosure, each field has a name which is displayed as the column header in the user interface. In one aspect of the present disclosure, the value in the field represents the status of that name or the status of what that name represents. This way, the value in each property of the return element is set by applying a criterion on each corresponding property in the input data.

The Display Status Data Step 950 is a step in which the results of the Data Analysis Step 940 are displayed on a user interface. Once the data is sent to the user interface, each element in the table will have a characteristic base on the values in the return elements. The characteristics can be different colors, font type, or different symbol that represents different statuses or conditions of the data.

The flow of the Data Analysis Process Overview flowchart 900 is described herein. To initiate the data analysis process, the user or system must trigger the process via the Start Step 910, either by pressing on a button or a keyboard key, clicking on a button, clicking on a link, or by any other triggering event. Once the process has been started, the system sends a request to the Data Source 930 for information related to the request via the Request Data Step 920. The data from the Data Source 930 is sent back to the system, which performs the Data Analysis Step 940 using the data obtained from the Data Source 930. After completing the Data Analysis Step 940, the system executes the Display Status Data Step 950, wherein the system displays the results of the Data Analysis Step 940.

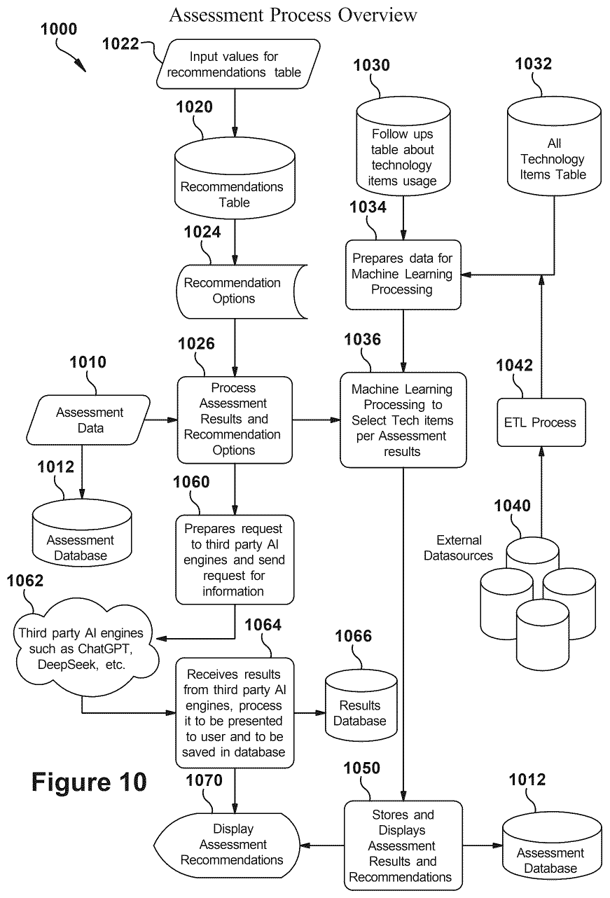

FIG. 10 schematically presents an Assessment Process Overview flowchart 1000. The Assessment Process Overview flowchart 1000 includes an Assessment Data Step 1010, an Assessment Database 1012, a Recommendations Table 1020, an Input Values for Recommendations Table step 1022, a Recommendation Options step 1024, a Process Assessment Results and Recommendation Options step 1026, a Follow Ups Table 1030, an All Technology Items Table 1032, a Prepares Data for Machine Leaning Processing step 1034, a Machine Learning Processing to Select Tech Items per Assessment Results step 1036, External Datasources 1040, an ETL Process 1042, a Stores and Displays Assessment Results and Recommendations step 1050, a Prepares Request to Third Party AI Engines step 1060, a Third Party AI Engines 1062, a Receives Results from Third Party AI Engines step 1064, a Results Database 1066, and a Display Assessment Recommendations step 1070.

The Assessment Data Step 1010 is a step in which the system conducts an assessment of an asset or patient.

The Assessment Database 1012 is a database in which the system stores information regarding the assessments conducted during the Assessment Data Step 1010.

The Recommendations Table 1020 is a table in which the system stores information regarding predefined results to support the meaning of the results of assessments conducted by the system. The system will use the information from the Recommendations Table 1020 to make recommendations related to assessments conducted by the system.

The Input Values for Recommendations Table step 1022 is a step in which the user may input data into the system related to recommendations that the system will make.

The Recommendation Options step 1024 is a step in which the system generates options available to the system to recommend based on the results of the Assessment Data step 1010.

The Process Assessment Results and Recommendation Options step 1026 is a step in which the system, based on the options generated during the Recommendation Options step 1024 based on the information stored in the Recommendations Table 1020, processes the assessment data from the Assessment Data Step 1010 to create a set of conditions for an individual being evaluated.

The Follow Ups Table 1030 is a table in which the results of a follow up are stored. In one aspect of the present disclosure, when a technology is assigned to a patient, there will be a follow up appointment, the results of which will be stored in the Follow Ups Table 1030.

The All Technology Items Table 1032 is a table in which information regarding all of the technologies available to the system is stored. In one aspect of the present disclosure, the All Technology Items Table 1032 includes a table of the assets available to the system. In another aspect of the present disclosure, the All Technology Items Table 1032 includes a table of the safety related assts available to the system. In yet another aspect of the present disclosure, the All Technology Items Table 1032 includes a table of the assistive technologies available to the system.

The Prepares Data for Machine Leaning Processing step 1034 is a step in which the system extracts data from the Follow Ups Table 1030 and the All Technology Items Table 1032 and prepares it for use in the Machine Learning Processing to Select Tech Items per Assessment Results step 1036.

The Machine Learning Processing to Select Tech Items per Assessment Results step 1036 is a step in which the system uses the results of the Process Assessment Results and Recommendation Options step 1026 and information prepared in the Prepares Data for Machine Leaning Processing step 1034 to determine what technology is best suited for a patient based on a model constructed using the information prepared in the Prepares Data for Machine Leaning Processing step 1034.

The External Datasources 1040 are one or more databases in which information regarding technologies available in the market is stored.

The ETL Process 1042 is a process in which the system processes information from the one or more databases in the External Datasources 1040 using the ETL method, making the information available for use by the system during the performance of the Prepares Data for Machine Leaning Processing step 1034.

The Stores and Displays Assessment Results and Recommendations step 1050 is a step in which the system stores the results of the Machine Learning Processing to Select Tech Items per Assessment Results step 1036 in the Assessment Database 1012 and prepares these results for display.

The Prepares Request to Third Party AI Engines step 1060 is a step in which the system prepares and sends one or more requests to one or more third party AI engines by formatting the results of the Process Assessment Results and Recommendation Options step 1026 into a natural language format to be sent to the one or more external third party AI engines.

The Third Party AI Engines 1062 are one or more external third party AI engines that are used by the system to gather more information about the results and recommendations made during the performance of the Process Assessment Results and Recommendation Options step 1026.

The Receives Results from Third Party AI Engines step 1064 is a step in which the system receives the results of the one or more requests sent to the Third Party AI Engines 1062 and processes the results for displaying to the user.

The Results Database 1066 is a database in which the results of the one or more requests sent to the Third Party AI Engines 1062 that were processed by the system during the performance of the Receives Results from Third Party AI Engines step 1064 are stored.

The Display Assessment Recommendations step 1070 is a step in which the system displays the results of the Assessment Data step 1010, the Process Assessment Results and Recommendation Options step 1026, the Machine Learning Processing to Select Tech Items per Assessment Results step 1036, and the Receives Results from Third Party AI Engines step 1064.

The flow of the Assessment Process Overview flowchart 1000 is described herein. The Assessment Data Step 1010 is performed by the system, the results of which are stored in the Assessment Database 1012. In preparation for the Process Assessment Results and Recommendation Options step 1026, the system performs the Recommendation Options step 1024, wherein the system extracts information regarding possible recommendations from the Recommendations Table 1020 to create options for the system to choose from during the Process Assessment Results and Recommendation Options step 1026. The Recommendations Table 1020 may be filled/augmented during the Input Values for Recommendations Table step 1022, wherein the user may input information related to the creation of recommendations by the system. The system then performs the Process Assessment Results and Recommendation Options step 1026, which uses the results of the Assessment Data step 1010, along with information regarding recommendation options created during the Process Assessment Results and Recommendation Options step 1026. In preparation for the Machine Learning Processing to Select Tech Items per Assessment Results step 1036, the system then performs the Prepares Data for Machine Leaning Processing step 1034, wherein information from the Follow Ups Table 1030 and the All Technology Items Table 1032, along with information from the External Datasources 1040 that has been through the ETL Process 1042, is processed to prepare it for use in the Machine Learning Processing to Select Tech Items per Assessment Results step 1036. The system then performs the Machine Learning Processing to Select Tech Items per Assessment Results step 1036, wherein a model is constructed using the information prepared during the Prepares Data for Machine Leaning Processing step 1034. The model then uses the results of the Process Assessment Results and Recommendation Options step 1026 to find what technology is best suited for the patient. The system then performs the Stores and Displays Assessment Results and Recommendations step 1050, wherein the results of the Machine Learning Processing to Select Tech Items per Assessment Results step 1036 are stored in the Assessment Database 1012. The system then performs the Prepares Request to Third Party AI Engines step 1060, wherein the results of the Process Assessment Results and Recommendation Options step 1026 are formatted into a natural language format to be sent to the Third Party AI Engines 1062. The formatted results from the Prepares Request to Third Party AI Engines step 1060 are then sent to the Third Party AI Engines 1062 to gather additional information regarding the results and recommendations made during the Process Assessment Results and Recommendation Options step 1026. The system then performs the Receives Results from Third Party AI Engines step 1064, wherein the results gleaned from the Third Party AI Engines 1062 are processed. The results of the Receives Results from Third Party AI Engines step 1064 are then stored in the Results Database 1066. The system then performs the Display Assessment Recommendations step 1070, wherein the results of the Machine Learning Processing to Select Tech Items per Assessment Results step 1036, as stored by the Stores and Displays Assessment Results and Recommendations step 1050, are displayed for the user to view and use.

The specifics of this system are described herein. The backend of this system has artificial intelligence engines that provide support to predict or assess the condition of an asset or item being analyzed. For each asset or item, the system provides a mechanism that brings analytical capabilities rather than having a program to gather and store data only. Those analytical capabilities are implementing machine learning algorithms.

This system is designed to gather quantitative data to represent qualitative data by using a set of questions that represent events, conditions, or situations. This data gathering process may be done either by an individual, a third-party program, or the system. Each question uses a scale of P to Q, where Q is a number greater than or equal to P. In one aspect of the present disclosure, each question uses a scale of 1 to Q, Q being an integer greater than or equal to 1, to assess each question and to represent each answer. Each answer is a number that is stored in a database table to form a collection of records. In one aspect of the present disclosure, each of these answers are stored in the Follow Ups Table 1030. Each table has columns (or fields) that are used to build models. In one aspect of the present disclosure, these columns represent a feature to be considered and are of type int (integer). The value in these columns represent the observations of the individual, program, or system that performed the assessment or inspection. In another aspect of the present disclosure, these observations of the individual, program, or system may take the form of but are not limited to the following forms: a written report, audio recording, or a video recording.

After having a certain number of records, the values are extracted and processed via the performance of the Prepares Data for Machine Leaning Processing step 1034 to build a data structure used to train an AI model such as a linear regression model or any other type of model. Each model represents the ideal situation of a given event, condition, or situation, meaning that each model represents the 100% situation. These models are used by the system to compare the 100% situation to the situation evaluated by the AI model. The system will then assign a value between 0% and 100% corresponding to how close the situation evaluated by the AI model compares to the ideal situation via the performance of the Machine Learning Processing to Select Tech Items per Assessment Results step 1036.

When an analysis is performed on a specific record, the values in that record are compared to the rest of the records used to train one or more applicable models. This evaluation is called a prediction, the specifics of which are described in the Prediction Process Software Operational Flow flowchart 600. Predictions are a measure of how close the evaluated situation is to the ideal situation, which in one aspect of the present disclosure is between 0% and 100%, with 100% being the ideal situation.

The system also presents a table of the conditions being evaluated and the status of each evaluation, shown as the Multiple Element Status Interface with Inserted Reports 800 in FIG. 8. The table is generated by finding data for each condition to evaluate and by indicating in the table if a record was found or not. If the user clicks on or otherwise interacts with an item that has no data, a form opens to allow the user to input the missing data. If the user clicks on or otherwise interacts with an item that has data, the same form opens but it is populated with the data for that item. The AI engines may also fill in this missing data automatically by looking at previous records and data to predict what the missing data should be. This function may be performed through the use of the ETL process 1040, making data from external data sources usable by the system to save the data into databases.

In one aspect of the present disclosure, the AI engines and models utilized by this system are machine learning programs that use past and present information and models to predict future conditions.

In one aspect of the present disclosure, this system includes a program to perform condition assessment inspections of physical assets of a company using the process described in the Detailed Description of the Assessment Process flowchart 300. The program is configured to do the condition assessment of wastewater treatment plants, but it can be customized to do the condition assessment of any type of physical asset. The software includes a backend, a front end accessible through a web browser and/or a mobile application to perform condition assessments in situ. The program includes the capability to analyze and indicate the present efficiency of the asset.

This aspect of the present disclosure uses structured written descriptions of the asset in assessing the asset. These written descriptions may take the form of multiple-choice-type questions that reflect the condition of the asset being analyzed.

In another aspect of the present disclosure, this system includes a program to assess existing safety conditions of a company or location using the process described in the Detailed Description of the Assessment Process flowchart 300. The system also provides guidance on how efficient the safety implementations are through an evaluation of the efficiency of the safety elements in place in a company. The system includes a backend, a front end accessible through a web browser and/or a mobile application to perform safety inspections in situ.

This aspect of the present disclosure may be used to evaluate conditions including but not limited to: biological hazards, electrical hazards, ergonomic hazards, fire hazards, floor and walkway conditions, general workplace conditions, ladder and fall protections, light conditions, machine guarding, mechanical safety conditions, noise conditions, personal protective equipment, and other safety conditions.

This aspect of the present disclosure may also utilize safety incident reports to help evaluate safety conditions of a company or location.

In this aspect of the present disclosure, the system uses AI engines and models to assess one or more items or conditions based on one or more models built with “positive” situation values, wherein “positive” means the item is working properly or the condition is adequately safe. For example, instead of saying that an item is likely to be broken, the system would say that, from one to five, three is the way the item is working. This means that the system will provide results representing how close to good condition the one or more items are in or how close to adequately safe a condition is.

In yet another aspect of the present disclosure, the system includes AI powered software designed to assess an individual's capability and assign assistive technology for her daily activities from the All Technology Items Table 1032. The system also facilitates managing how the individual is taking advantage of the assigned technology via the performance of the Machine Learning Processing to Select Tech Items per Assessment Results step 1036. The system includes a backend and a front end accessible through a web browser and/or a mobile surrogate to perform usage assessments.

This aspect of the present disclosure assesses an individual who has one or more disabilities and who is under the monitoring of a supervisor (the “patient”), who can be a social worker or a ward. Once the need to provide a technological device is identified and the technological device is assigned to the patient, the supervisor uses the system to assess how the patient is using or responding to using the technology by filling out a multiple-choice questionnaire. This includes metrics such as ease of use of the assigned technology and the level of difficulty in training the patient to use the assigned technology. This multiple-choice questionnaire may have any number of questions, wherein each choice represents a scale value that goes from 1 to Q, where Q is an integer greater than or equal to 1. The results are stored in a database for each patient. The AI engines use this information and information from previous assessments to assess how the patient is responding to using the technology or technologies they have been assigned. In one aspect of the present disclosure, the assessment provided by the system is in the form of a percentage, where the higher the percentage is, the better the patient is utilizing the technological device. This information may be used by the system or a supervisor to make a decision regarding the technological device and how it is used by the patient.

In one aspect of the present disclosure, the system may generate reminders regarding deadlines for tasks and other scheduled events to notify and remind the user of the upcoming event or deadline. These reminders are viewable by the user via the Multiple Element Status Interface with Inserted Reports 800. These reminders may also be created or modified manually by the user.

In another aspect of the present disclosure, the system may generate schedules regarding the monitoring and/or inspection of safety conditions, safety systems, and safety related assets to ensure that they are monitored and inspected regularly according to their respective needs. These schedules are viewable by the user via the Multiple Element Status Interface with Inserted Reports 800. These schedules may also be created in relation to patients and their respective assistive technologies, ensuring that each patient is monitored at a regular interval and their respective assistive technologies are inspected regularly. These schedules may also be created or modified manually by the user. The system may also determine the likelihood of a task being completed on time, based on gathered information. The system, using this information, may automatically assign a task to the individual who the system believes will be most likely to complete the task on time.

In one aspect of the present disclosure, the system takes the results of the Receives Results from Third Party AI Engines step 1064 and generates a recommendations report of what should be done to improve the condition and/or situation analyzed by the system using the processes described in the Detailed Description of the Assessment Process flowchart 300 and/or the Assessment Process Overview flowchart 1000. This recommendations report is generated by the system automatically without any additional human input or intervention. This recommendations report provides steps for the user to take in order to improve the condition of an asset and/or situation with the goal of getting closer to the ideal situation. In one aspect of the present disclosure, this recommendations report informs the user how far off the asset and/or condition is from the ideal situation and provides instructions for the user on how to improve the condition of the asset and/or situation to match the ideal situation. In another aspect of the present disclosure, this recommendations report assigns a percentage to the asset and/or situation, this percentage being a measure of how close the evaluated situation is to the ideal situation, which in this aspect of the present disclosure is between 0% and 100%, with 100% being the ideal situation.

It is to be understood that a mobile device may be any appropriate portable computing device, such as a smart phone, laptop, tablet PC, smart watch, mobile internet devices, wearable computers, personal digital assistants, enterprise digital assistants, handheld game consoles, portable media players, ultra-mobile PCs, and/or smart cards, as non-limiting examples.

Non-limiting aspects have been described, hereinabove. It will be apparent to those skilled in the art that the above methods and apparatuses may incorporate changes and modifications without departing from the general scope of the present subject matter. It is intended to include all such modifications and alterations in so far as they come within the scope of the appended claims or the equivalents thereof.

Clause 1—A system for executing an asset condition assessment, the system comprising one or more non-transitory computer-readable storage media containing a set of instructions executable by one or more logic machines to perform the steps of initiating the asset condition assessment for execution by the system, wherein a user triggers the start of the asset condition assessment, receiving client information regarding one or more assets, wherein the user provides the client information in the form of a written description or as answers to questions, via a web browser or an app, storing the client information, wherein the system takes the client information provided by the user, translates it into a format that is readable by the system, and then stores it as stored client information, wherein the system may access the stored client information and retrieve data from it when needed, evaluating the stored client information using an evaluation process, wherein the system, using one or more AI models, evaluates the stored client information to determine the condition and efficiency of one or more assets, wherein the one or more AI models are trained using a training process to create one or more trained AI models, the training process including the steps of accessing training data from one or more data sources, organizing the training data in a structured way, wherein the training data may be viewed as a collection of records viewable as a table, wherein each row is a record with at least one attribute or value, instantiating a trainer class, wherein a representative dataset from the training data is used to instantiate the trainer class, running a training algorithm on the trainer class to produce one or more model files, and storing the one or more model files for later use by the system, wherein the stored client information is used by the one or more trained AI models to determine the condition and efficiency of the one or more assets, wherein the system transforms the stored client information into the same data type as the trainer class, and compares the stored client information to the one or more model files to determine the condition and/or efficiency of the one or more assets, wherein the one or more trained AI models may fill information missing in the stored client information by looking at the one or more model files and the training data and automatically predicting what the missing information should be, and wherein the one or more trained AI models compares the stored client information to an ideal situation dataset of the one or more assets, wherein the ideal situation dataset comprises data that represents the theoretical maximum level of efficiency, quality, efficacy, or condition of the one or more assets, and then assigns a value between 0% and 100% corresponding to how close the stored client information evaluated by the one or more trained AI models compares to the ideal situation dataset of the one or more assets, compiling the results of the asset condition assessment and storing them in a database, displaying the results of the asset condition assessment for viewing and use by the user; and generating one or more recommendations reports, wherein the one or more recommendations reports include recommendations for the user to follow to improve the condition of the one or more assets, wherein the recommendations are made based on the results of the asset condition assessment.

Clause 2—The system of clause 1, wherein the one or more assets assessed are physical assets.

Clause 3—The system of clauses 1 or 2, wherein the one or more assets assessed are associated with wastewater treatment facilities.

Clause 4—The system of clauses 1-3, wherein the stored client information used by the system comprises a questionnaire.

Clause 5—The system of clause 4, wherein the questionnaire used by the system comprises one or more multiple-choice-type questions.

Clause 6—The system of clauses 4 or 5, wherein the questionnaire used by the system comprises a field for the entry of comments by the user.

Clause 7—The system of clauses 1-6, wherein information missing in the stored client information is insertable into the stored client information by the user.

Clause 8—A system for executing a safety conditions assessment, the system comprising one or more non-transitory computer-readable storage media containing a set of instructions executable by one or more logic machines to perform the steps of initiating the safety conditions assessment for execution by the system, wherein a user triggers a start of the safety conditions assessment, receiving client information regarding one or more safety conditions, one or more safety systems, and one or more safety related assets, wherein the user provides client information in the form of a written description or as answers to questions, via a web browser or an app, storing the client information, wherein the system takes the client information provided by the user, translates the client information into a format that is readable by the system, and then stores the system readable client information as stored client information wherein the stored client information is accessible and retrieves the stored client information when needed, evaluating the stored client information using an evaluation process, wherein the system, using one or more AI models, evaluates the stored information to determine the state of the one or more safety conditions and effectiveness and condition of the one or more safety systems and the one or more safety related assets, wherein the one or more AI models are trained using a training process to create one or more trained AI models, the training process including the steps of accessing training data from one or more data sources, organizing the training data in a structured way, wherein the training data may be viewed as a collection of records viewable as a table wherein each row is a record with at least one attribute or value, instantiating a trainer class, wherein a representative dataset from the training data is used to instantiate the trainer class, running a training algorithm on the trainer class to produce one or more model files, and storing the one or more model files for later use by the system, wherein the stored client information is used by the one or more trained AI models to determine the state of the one or more safety conditions and effectiveness and condition of the one or more safety systems and the one or more safety related assets, wherein the system transforms the stored client information into the same data type as the trainer class, and compares the stored client information to the one or more model files to determine the state of the one or more safety conditions and effectiveness and condition of the one or more safety systems and the one or more safety related assets, wherein the one or more trained AI models may fill information missing in the stored client information by looking at the one or more model files and the training data and predicting what the missing information should be, and wherein the one or more trained AI models compares the stored client information to an ideal situation dataset of the one or more safety conditions and effectiveness and condition of the one or more safety systems and the one or more safety related assets, wherein the ideal situation dataset comprises data that represents the theoretical maximum level of efficiency, quality, efficacy, or condition of the one or more safety conditions and effectiveness and condition of the one or more safety systems and the one or more safety related assets, and then assigns a value between 0% and 100% corresponding to how close the stored client information evaluated by the one or more trained AI models compares to the ideal situation dataset of the one or more safety systems and the one or more safety related assets, compiling the results of the safety conditions assessment and storing them in a database, displaying the results of the safety conditions assessment for viewing and use by the user; and generating one or more recommendations reports, wherein the one or more recommendations reports include recommendations for the user to follow to improve the condition of the one or more safety systems and the one or more safety related assets, wherein the recommendations are made based on the results of the safety conditions assessment.

Clause 9—The system of clause 8, wherein the one or more safety related assets assessed are physical assets.

Clause 10—The system of clauses 8 or 9, wherein the system may generate one or more schedules wherein the one or more schedules serve to ensure that the one or more safety conditions and effectiveness and condition of the one or more safety systems and the one or more safety related assets are monitored and inspected regularly according to their respective needs.

Clause 11—The system of clauses 8-10, wherein the stored client information used by the system comprises a questionnaire.

Clause 12—The system of clause 11, wherein the questionnaire used by the system comprises one or more multiple-choice-type questions.

Clause 13—The system of clauses 11 or 12, wherein the questionnaire used by the system comprises a field for the entry of comments by the user.

Clause 14—The system of clauses 8-13, wherein information missing in the stored client information is insertable into the stored client information by the user.

Clause 15—A system for executing a personal capabilities assessment of one or more patients, the system comprising one or more non-transitory computer-readable storage media containing a set of instructions executable by one or more logic machines to perform the steps of initiating the personal capabilities assessment, wherein a user triggers the start of the personal capabilities assessment, receiving patient information regarding the one or more patients' capabilities, wherein the user provides client information in the form of a written description or as answers to questions, via a web browser or an app, storing the client information, wherein the system takes the client information provided by the user, translates it into a format that is readable by the system, and then stores the system readable client information as stored client information wherein the system may access the stored client information and retrieve the stored client information when needed, evaluating the stored client information, wherein the system, using one or more AI models, evaluates the stored client information to determine the capabilities and needs of the one or more patients, wherein the one or more AI models are trained using a training process to create one or more trained AI models, the training process including the steps of accessing training data from one or more data sources, organizing the training data in a structured way, wherein the training data is viewable as a collection of records that is viewable as a table, wherein each row is a record with at least one attribute or value, instantiating a trainer class, wherein a representative dataset from the training data is used to instantiate the trainer class, running a training algorithm on the trainer class to produce one or more model files, and storing the one or more model files for later use by the system, wherein the system uses the trainer class to predict the level of ability of the one or more patients and determine what assistive technology they need based on the stored client information, wherein the stored client information is used by the one or more trained AI models to determine the capabilities and needs of the one or more patients, wherein the system transforms the stored client information into the same data type as the trainer class, and compares the stored client information to the one or more model files to determine the capabilities and needs of the one or more patients, wherein the one or more trained AI models inputs information missing in the stored client information by looking at the one or more model files and the training data and predicting what the missing information should be, and wherein the one or more trained AI models compares the stored client information to an ideal situation dataset of the one or more patients and the assistive technology assigned to them, wherein the ideal situation dataset comprises data that represents the theoretical optimal condition of the one or more patients and the theoretical maximum level of efficiency, quality, efficacy, or condition of the assistive technology assigned to the one or more patients, and then assigns a value between 0% and 100% corresponding to how close the stored client information evaluated by the one or more trained AI models compares to the ideal situation dataset of the one or more patients and the assistive technology assigned to the one or more patients, compiling the results of the personal capabilities assessment and storing the results in a database, displaying the results of the personal capabilities assessment for viewing and use by the user; and generating one or more recommendations reports, wherein the one or more recommendations reports include recommendations for the user to follow to improve the condition of the one or more patients and the assistive technology assigned to the one or more patients, wherein the recommendations are made based on the results of the personal capabilities assessment.

Clause 16—The system of clause 15, wherein the stored client information used by the system comprises a questionnaire.

Clause 17—The system of clause 16, wherein the questionnaire used by the system comprises one or more multiple-choice-type questions.

Clause 18—The system of clauses 16 or 17, wherein the questionnaire used by the system comprises a field for the entry of comments by the user.

Clause 19—The system of clauses 15-18, wherein information missing in the stored client information is insertable into the stored client information by the user.

Clause 20—The system of clauses 15-19, wherein the system generates one or more schedules wherein the one or more schedules serve to ensure that the one or more patients them monitored at a regular interval and the assistive technology assigned to the one or more patients are inspected regularly.

We claim:

1. A system for executing an asset condition assessment, the system comprising one or more non-transitory computer-readable storage media containing a set of instructions executable by one or more logic machines to perform the steps of:
initiating the asset condition assessment for execution by the system, wherein a user triggers the start of the asset condition assessment;
receiving client information regarding one or more assets, wherein the user provides the client information in the form of a written description or as answers to questions, via a web browser or an app;
storing the client information, wherein the system takes the client information provided by the user, translates it into a format that is readable by the system, and then stores it as stored client information in such a way that the system may access the stored client information and pull data from it when needed;
evaluating the stored client information using an evaluation process, wherein the system, using one or more AI models, evaluates the stored client information to determine the condition and efficiency of one or more assets,
wherein the one or more AI models are trained using a training process to create one or more trained AI models, the training process comprising the steps of:
accessing training data from one or more data sources;
organizing the training data in a structured way, wherein the training data may be viewed as a collection of records viewable as a table, wherein each row is a record with at least one attribute or value;
instantiating a trainer class, wherein a representative dataset from the training data is used to instantiate the trainer class;
running a training algorithm on the trainer class to produce one or more model files; and
storing the one or more model files for later use by the system;
wherein the stored client information is used by the one or more trained AI models to determine the condition and efficiency of the one or more assets, wherein the system transforms the stored client information into the same data type as the trainer class, and compares the stored client information to the one or more model files to determine the condition and/or efficiency of the one or more assets;
wherein the one or more trained AI models may fill information missing in the stored client information by looking at the one or more model files and the training data and automatically predicting what the missing information should be; and
wherein the one or more trained AI models compares the stored client information to an ideal situation dataset of the one or more assets, wherein the ideal situation dataset comprises data that represents the theoretical maximum level of efficiency, quality, efficacy, or condition of the one or more assets, and then assigns a value between 0% and 100% corresponding to how close the stored client information evaluated by the one or more trained AI models compares to the ideal situation dataset of the one or more assets;
compiling the results of the asset condition assessment and storing them in a database;
displaying the results of the asset condition assessment for viewing and use by the user; and
generating one or more recommendations reports, wherein the one or more recommendations reports include recommendations for the user to follow to improve the condition of the one or more assets, wherein the recommendations are made based on the results of the asset condition assessment.

2. The system of claim 1, wherein the one or more assets assessed are physical assets.

3. The system of claim 1, wherein the one or more assets assessed are associated with wastewater treatment facilities.

4. The system of claim 1, wherein the stored client information used by the system comprises a questionnaire.

5. The system of claim 4, wherein the questionnaire used by the system comprises one or more multiple-choice-type questions.

6. The system of claim 4, wherein the questionnaire used by the system comprises a field for the entry of comments by the user.

7. The system of claim 1, wherein information missing in the stored client information is insertable into the stored client information by the user.

8. A system for executing a safety conditions assessment, the system comprising one or more non-transitory computer-readable storage media containing a set of instructions executable by one or more logic machines to perform the steps of:
initiating the safety conditions assessment for execution by a system, wherein a user triggers the start of the safety conditions assessment;
receiving client information regarding one or more safety conditions, one or more safety systems, and one or more safety related assets, wherein the user provides client information in the form of a written description or as answers to questions, via a web browser or an app;
storing the client information, wherein the system takes the client information provided by the user, translates the client information into a format that is readable by the system, and then stores the system readable client information as stored client information wherein the stored client information is accessible and retrieves the stored client information when needed;
evaluating the stored client information using an evaluation process, wherein the system, using one or more AI models, evaluates the stored information to determine the state of the one or more safety conditions and effectiveness and condition of the one or more safety systems and the one or more safety related assets,
wherein the one or more AI models are trained using a training process to create one or more trained AI models, the training process comprising the steps of:
accessing training data from one or more data sources;
organizing the training data in a structured way, wherein the training data may be viewed as a collection of records viewable as a table wherein each row is a record with at least one attribute or value;
instantiating a trainer class, wherein a representative dataset from the training data is used to instantiate the trainer class;
running a training algorithm on the trainer class to produce one or more model files; and
storing the one or more model files for later use by the system;
wherein the stored client information is used by the one or more trained AI models to determine the state of the one or more safety conditions and effectiveness and condition of the one or more safety systems and the one or more safety related assets, wherein the system transforms the stored client information into the same data type as the trainer class, and compares the stored client information to the one or more model files to determine the state of the one or more safety conditions and effectiveness and condition of the one or more safety systems and the one or more safety related assets;
wherein the one or more trained AI models may fill information missing in the stored client information by looking at the one or more model files and the training data and predicting what the missing information should be; and
wherein the one or more trained AI models compares the stored client information to an ideal situation dataset of the one or more safety conditions and effectiveness and condition of the one or more safety systems and the one or more safety related assets, wherein the ideal situation dataset comprises data that represents the theoretical maximum level of efficiency, quality, efficacy, or condition of the one or more safety conditions and effectiveness and condition of the one or more safety systems and the one or more safety related assets, and then assigns a value between 0% and 100% corresponding to how close the stored client information evaluated by the one or more trained AI models compares to the ideal situation dataset of the one or more safety systems and the one or more safety related assets;
compiling the results of the safety conditions assessment and storing them in a database;
displaying the results of the safety conditions assessment for viewing and use by the user; and
generating one or more recommendations reports, wherein the one or more recommendations reports include recommendations for the user to follow to improve the condition of the one or more safety systems and the one or more safety related assets, wherein the recommendations are made based on the results of the safety conditions assessment.

9. The system of claim 8, wherein the one or more safety related assets assessed are physical assets.

10. The system of claim 8, wherein the system may generate one or more schedules wherein the one or more schedules serve to ensure that the one or more safety conditions and effectiveness and condition of the one or more safety systems and the one or more safety related assets are monitored and inspected regularly according to their respective needs.

11. The system of claim 8, wherein the stored client information used by the system comprises a questionnaire.

12. The system of claim 11, wherein the questionnaire used by the system comprises one or more multiple-choice-type questions.

13. The system of claim 11, wherein the questionnaire used by the system comprises a field for the entry of comments by the user.

14. The system of claim 8, wherein information missing in the stored client information is insertable into the stored client information by the user.

15. A system for executing a personal capabilities assessment of one or more patients, the system comprising one or more non-transitory computer-readable storage media containing a set of instructions executable by one or more logic machines to perform the steps of:
initiating the personal capabilities assessment, wherein a user triggers the start of the personal capabilities assessment;
receiving patient information regarding the one or more patients' capabilities, wherein the user provides client information in the form of a written description or as answers to questions, via a web browser or an app;
storing the client information, wherein the system takes the client information provided by the user, translates it into a format that is readable by the system, and then stores the system readable client information as stored client information wherein the system may access the stored client information and retrieve the stored client information when needed;
evaluating the stored client information, wherein the system, using one or more AI models, evaluates the stored client information to determine the capabilities and needs of the one or more patients,
wherein the one or more AI models are trained using a training process to create one or more trained AI models, the training process comprising the steps of:
accessing training data from one or more data sources;
organizing the training data in a structured way, wherein the training data is viewable as a collection of records that is viewable as a table, wherein each row is a record with at least one attribute or value;
instantiating a trainer class, wherein a representative dataset from the training data is used to instantiate the trainer class;
running a training algorithm on the trainer class to produce one or more model files; and
storing the one or more model files for later use by the system;
wherein the system uses the trainer class to predict the level of ability of the one or more patients and determine what assistive technology they need based on the stored client information;
wherein the stored client information is used by the one or more trained AI models to determine the capabilities and needs of the one or more patients, wherein the system transforms the stored client information into the same data type as the trainer class, and compares the stored client information to the one or more model files to determine the capabilities and needs of the one or more patients;
wherein the one or more trained AI models inputs information missing in the stored client information by looking at the one or more model files and the training data and predicting what the missing information should be; and
wherein the one or more trained AI models compares the stored client information to an ideal situation dataset of the one or more patients and the assistive technology assigned to them, wherein the ideal situation dataset comprises data that represents the theoretical optimal condition of the one or more patients and the theoretical maximum level of efficiency, quality, efficacy, or condition of the assistive technology assigned to the one or more patients, and then assigns a value between 0% and 100% corresponding to how close the stored client information evaluated by the one or more trained AI models compares to the ideal situation dataset of the one or more patients and the assistive technology assigned to the one or more patients;
compiling the results of the personal capabilities assessment and storing the results in a database;
displaying the results of the personal capabilities assessment for viewing and use by the user; and
generating one or more recommendations reports, wherein the one or more recommendations reports include recommendations for the user to follow to improve the condition of the one or more patients and the assistive technology assigned to the one or more patients, wherein the recommendations are made based on the results of the personal capabilities assessment.

16. The system of claim 15, wherein the stored client information used by the system comprises a questionnaire.

17. The system of claim 16, wherein the questionnaire used by the system comprises one or more multiple-choice-type questions.

18. The system of claim 16, wherein the questionnaire used by the system comprises a field for the entry of comments by the user.

19. The system of claim 15, wherein information missing in the stored client information is insertable into the stored client information by the user.

20. The system of claim 15, wherein the system generates one or more schedules wherein the one or more schedules serve to ensure that the one or more patients them monitored at a regular interval and the assistive technology assigned to the one or more patients are inspected regularly.
